(19) United States
(12) Patent Application Publication
(10) Pub. No.: US 2026/0172464 A1
(43) Pub. Date: Jun. 18, 2026

(54) METHOD FOR CHECKING THE SHARED DELIVERY OF AN ITEM OF CONTENT

(71) Applicant: Orange, Issy-Les-Moulineaux (FR)

(72) Inventors: Frédéric FIEAU, Chatillon Cedex (FR); Gaël FROMENTOUX, Chatillon Cedex (FR); Romuald CORBEL, Chatillon Cedex (FR); Emile STEPHAN, Chatillon Cedex (FR)

(21) Appl. No.: 18/575,049

(22) PCT Filed: Jun. 29, 2022
(86) PCT No.: PCT/FR2022/051295

§ 371 Date: Dec. 28, 2023

(30) Foreign Application Priority Data
Jun. 30, 2021 (FR) FR2107057

(51) Int. Cl. H04L 65/80; G06Q 20/12; H04L 65/75

(52) U.S. Cl. CPC H04L 65/80; G06Q 20/123; H04L 65/75

(57) ABSTRACT

A solution in which, an item of content to be delivered being split into a plurality of portions, these various portions are transmitted by various nodes of content delivery networks in order to guarantee, in particular, a content delivery rate. Known solutions for shared delivery of an item of content cannot guarantee that the requested content will be delivered at the rate and quality required by the user terminal. The solution conditions a reward to be given to the content delivery network, or its manager, to meeting transmission conditions embodied in expected telemetry data for the delivery of an item of content. Such a solution offers more certainty to the user requesting the content as regards to the quality of the delivery made by a group of nodes since the quality of the transmission is guaranteed.

### CROSS-REFERENCE TO RELATED APPLICATIONS

This application is filed under 35 U.S.C. § 371 as the U.S. National Phase of Application No. PCT/FR2022/051295 entitled “METHOD FOR CHECKING SHARED CONTENT DELIVERY” and filed Jun. 29, 2022, and which claims priority to FR 2107057 filed Jun. 30, 2021, each of which is incorporated by reference in its entirety.

### BACKGROUND

### Field

The field of the development is that of delivering content to a user terminal. More specifically, the development relates to a solution in which, an item of content to be delivered being split into a plurality of portions, these various portions are transmitted by various nodes of content distribution networks in order to guarantee or increase, in particular, a content delivery rate. It should be noted that, in the context of the development, various nodes can transmit the same portion of the content or separate portions.

### Description of Related Art

With the increasing rate of communications networks, in particular thanks to the advent of networks compliant with the 4th generation of radio communication standards and the implementation of networks compliant with the 5th generation of radio communication standards, more and more users of terminals, such as mobile phones or any other mobile or non-mobile terminals, can stream or download content such as a live sporting or news event, a film or an item of audio content such as a podcast. This content is delivered by nodes of a content delivery network or CDN.

In known content delivery architectures, content servers, managed by one or more content providers, transmit content to server nodes, or CDN nodes belonging to one or more content delivery networks CDNs, in accordance with pre-established content supply and delivery contracts that include in particular information relating to the data transmission rate, transmission quality parameters as well as information relating to the volume of data to be transmitted by the nodes of the content delivery network to the user terminals that have requested an item of content.

When several stakeholders are involved in delivering the same content to the same user terminal, it is important to ensure that all stakeholders in the delivery fulfil their part of the contract.

Indeed, in such a situation, it is important for anyone to be able to ensure that the service provided complies with what has been negotiated between the parties.

However, current solutions for shared content delivery cannot guarantee that the requested content will be delivered in compliance with what has been negotiated between the parties.

There is therefore a need for a technique that does not have some or all of the above-mentioned disadvantages.

### SUMMARY

To this end, the development relates to a method for checking a delivery of an item of content to a user terminal made by a plurality of nodes belonging to at least one content delivery network, said nodes being able to deliver one or more portions of the content.

Such a method is implemented by a node referred to as the initiator node selected from the plurality of nodes and comprising the following steps:
comparing, for a plurality of portions of the content delivered, values of at least one actual item of telemetry data with corresponding values of at least one expected item of telemetry data,
receiving at least one result of the same comparisons performed by at least one second node, referred to as the follower node, selected from the plurality of nodes,
acknowledging the delivery of portions of the content when at least a majority of the comparison results obtained indicate compliance of the values of at least one actual item of telemetry data item with the values of at least one expected item of telemetry data.

The telemetry data being directly linked to the quality of content transmission, it is the data of choice for determining whether the content delivery conditions are met and thus acknowledging the delivery of the content when they are validated by the majority or all of the nodes involved in the delivery of content, in other words, when a consensus is reached regarding the correct delivery of the content. A node involved in the delivery of the content does not necessarily deliver a portion of the content, a node participating in the delivery can measure the telemetry data values or simply participate in validating the comparison results.

The present solution allows all stakeholders involved in the delivery of the content to have access to telemetry data and thus to have a say in the content delivery process. This is particularly advantageous when these stakeholders are not handled by the same administrative entity (for example, by the same content delivery network operator).

According to a particular implementation of the method for checking delivery, the comparison results are weighted to determine whether a majority of the comparison results obtained indicate said compliance.

More particularly, a value of a weighting coefficient to be applied to the comparison results depends on at least one function implemented by nodes belonging to the plurality of nodes.

In such an implementation, the comparison results can be weighted in particular according to the nodes that calculated them. For example, the results calculated by the initiator node have a higher weighting coefficient. In another example, the results calculated by a node delivering a portion of the content have a lower weighting coefficient than a node measuring telemetry data.

According to a particular implementation of the method for checking delivery, the comparison results and/or said at least one actual item of telemetry data are accompanied by at least one item of information for verifying their integrity.

Indeed, all the nodes participating in the delivery of the content having access to the telemetry data values, it is important to ensure the integrity of the data and/or of the comparison results, in order to acknowledge the delivery of the content only when the majority of nodes are certain that all conditions have been met.

Thus, when the integrity of at least one of the comparison results or of one item of telemetry data is not verified, the delivery of portions of the content is not acknowledged.

According to a particular implementation of the method for checking delivery, an item of information for verifying the integrity of the comparison results and/or of said at least one actual item of telemetry data comprises a list comprising identifiers of nodes belonging to the plurality of nodes and/or comprises a hash of the data constituting at least comparison results and/or of said at least one actual item of telemetry data, and/or relates to at least one function implemented by nodes belonging to the plurality of nodes.

Thus, if data (telemetry data or comparison results) is provided by a non-referenced node, all nodes know that their integrity is compromised.

For example, the results calculated by the initiator node are considered to have integrity, as are those calculated by a node measuring telemetry data.

According to a particular implementation of the method for checking delivery, it comprises a step of receiving a request for the delivery of portions of the content sent by the user terminal, said delivery request comprising at least one value of at least one expected item of telemetry data relating to the delivery of portions of the content.

In this implementation, the user terminal indicates the delivery conditions for each requested content. Thus, the user terminal can modulate the conditions for the delivery of an item of content according to its environment. Thus, the conditions for the delivery of a requested item of content are different depending on whether the user terminal is using a Wi-Fi connection established with a home gateway or a cellular connection compliant with the 5^{th} generation of radio communication standards, for example.

According to another particular implementation of the method for checking delivery, it comprises, in response to receiving a request to deliver the content sent by the user terminal, a step of sending to the user terminal a message comprising an identifier of said at least one second node and values of at least one expected item of telemetry data.

In this particular implementation, the first node indicates the delivery conditions of the requested content to the user terminal. Knowing the nature and the capacities of the link established with the user terminal, as well as information relating to the services subscribed to by the user, the first node can determine the delivery conditions relating to the requested content and thus identify the other nodes that will participate in this delivery in order to guarantee compliance of the delivery with the services subscribed to by the user.

According to a characteristic of the method for checking the delivery of an item of content, it comprises, prior to the delivery of portions of the content, a step of creating a shared register relating to said content, intended to store data relating to the delivery of the content and to validate telemetry data relating to the delivery of portions of the content.

Setting up a register shared between the various nodes allows to propose the delivery of an item of content by means of several nodes not belonging to the same content delivery network, while guaranteeing the delivery conditions established between the user terminal and the first node are met.

The validation of all telemetry data submitted to all or some of the nodes involved in the delivery of the content guarantees an impartial validation of the results. Thus, a high level of trust is established between the various operators managing the nodes involved in delivery of the content.

Finally, such a shared register applies to specific content. This provides a fine compartmentalisation of information, making it easier for each of the managers of the delivery networks concerned to manage the delivery of content.

According to a characteristic of the method for checking the delivery of an item of content, the step of creating the shared registry comprises the following steps:
broadcasting a message comprising an address of a local register of the first node relating to delivery of the content,
receiving a request to set up a connection between the local register of the first node and a local register of the second node through which the data relating to the delivery of the content is exchanged.

In this implementation, the first node broadcasts a message indicating its ability to deliver a given item of content and comprising information relating to a local registry linked to that content. Such a local register serves as a reference register for the registers created in the other nodes involved in the delivery of the content. Any change occurring in the local register of the first node is replicated in the local registers of the other nodes after validation by all nodes.

According to a characteristic of the method for checking the delivery of an item of content, it comprises a negotiation step with said second node during which values of at least one expected item of telemetry data are determined.

During this negotiation step, the first node transmits the transmission conditions in terms of bit rate, transmission duration, etc., specific to the user terminal so that the second node can define expected telemetry data values for the delivery of the portion of content for which it is responsible.

According to a characteristic of the method for checking the delivery of an item of content, wherein during the negotiation step, the initiator node and the follower nodes further exchange data relating to a type of reward for the implementation of a reward relating to the delivery of said portions of the content.

Such a reward is, for example, a payment for the delivery of the content. In this example, the first node can transmit pricing schedules associated with the transmission conditions in terms of rate, transmission duration, as well as certain services (such as request routing, caching, transcoding . . . ) that other nodes could provide, etc., as well as the distribution arrangements.

Acknowledging the delivery of portions of the content triggers a payment transaction.

Conditioning a reward to be given to the content delivery network, or its manager, to meeting transmission conditions embodied in expected telemetry data offers more certainty to the user requesting the content as regards to the quality of the content that will be broadcast by a group of nodes, since the quality of the transmission is guaranteed.

The proposed solution is dynamic and offers an interesting flexibility of use, as it can be applied on a case-by-case basis. Indeed, the conditional reward concerns the transaction of one or more portions of a given item of content and the nodes involved in delivering that content. In other words, the transmission of new content by the same group of nodes or the transmission of the same content by another group of nodes triggers the creation of a new conditional reward associated with new expected telemetry data values. Indeed, the various nodes involved in delivering the requested content may belong to different content delivery networks.

As telemetry data is directly linked to the quality of content transmission, it is the data of choice for determining whether the conditions for triggering the reward are met.

In such a solution, the reward can be graduated. Indeed, if only a part of the negotiated transmission conditions is met, the reward may be allocated but it corresponds to a lesser compensation since the expected service has not been provided in full, or only certain nodes may receive the reward depending on whether or not they have met the delivery conditions. Thus, as an example, if the reward is an amount to be paid for the service provided, the tariff schedule may indicate a lower amount because not all the transmission conditions could be met.

Finally, in such a solution, two separate nodes can deliver the same portion of the content, so it is possible to reward, for example, the node that delivers the content more quickly.

According to a characteristic of the method for checking the delivery of an item of content, an item of telemetry data belongs to a group comprising among others:
a transit period between the initiator node, the follower nodes and the user terminal of a data packet constituting the content,
an identifier of at least one interconnection module routing at least one data packet constituting the content between the initiator node, the follower nodes and the user terminal, the identifier can advantageously comprise the identifier of an operator managing the interconnection module,
a transit time of a data packet constituting the content through an interconnection module, corresponding to the time when the interconnection module receives, processes or transmits the data packet,
a time for a data packet constituting the content to travel through the interconnection module,
a time for of a data packet constituting the content to be processed by the interconnection module,
a quality of service, representative of the prioritisation of the data packet constituting the content, this quality of service can be, for example, represented by a qualitative indication of the packet processing when it is routed to the user terminal,
receiving without delay and/or without loss or retransmission a group of data packets constituting at least a part of the content,
a combination of the above-mentioned individual items of telemetry data of the group.

The development also relates to a node of a content delivery network, referred to as the initiator node, capable of checking a delivery of an item of content to a user terminal made by a plurality of other nodes, said nodes being able to deliver one or more portions of the content.

Such a node comprises means for:
comparing, for a plurality of portions of the content delivered, values of at least one actual item of telemetry data with corresponding values of at least one expected item of telemetry data,
receiving at least one result of the same comparisons performed by at least one second node, referred to as the follower node, selected from the plurality of nodes,
acknowledging the delivery of portions of the content when at least a majority of the comparison results obtained indicate compliance of the values of at least one actual item of telemetry data item with the values of at least one expected item of telemetry data.

The purpose of the development is also a system comprising at least one user terminal and a plurality of nodes belonging to at least one content delivery network, said nodes being able to deliver one or more portions of an item of content to said user terminal, said system being characterised in that a first node referred to as the initiator node selected from the plurality of nodes comprises means for:
comparing, for a plurality of portions of the content delivered, values of at least one actual item of telemetry data with corresponding values of at least one expected item of telemetry data,
receiving at least one result of the same comparisons performed by at least one second node, referred to as the follower node, selected from the plurality of nodes,
acknowledging the delivery of portions of the content when at least a majority of the comparison results obtained indicate compliance of the values of at least one actual item of telemetry data item with the values of at least one expected item of telemetry data.

Finally, the development relates to a computer program product comprising program code instructions for implementing a method as described previously when it is executed by a processor.

The development also relates to a computer-readable storage medium on which is saved a computer program comprising program code instructions for implementing the steps of the method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method of the above-mentioned development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows a diagram of a system in which the present development can be implemented,

FIG. 2: this figure shows a diagram of the various steps of the method for checking the delivery of an item of content covered by the development,

FIG. 3: this figure shows a node capable of implementing the method for checking the delivery of an item of content covered by the development.

### DETAILED DESCRIPTION OF CERTAIN ILLUSTRATIVE EMBODIMENTS

The general principle of the development is based on sharing the delivery of an item of content to a user terminal, such as a mobile terminal or a connected television, between a plurality of nodes belonging or not to the same content delivery network, and on validating, by consensus between the various nodes involved in this delivery, the conditions under which this delivery was made. In order to manage this shared delivery of the content in the best manner possible, a shared registry is set up between the various nodes involved in delivering the requested content to the user terminal. This shared register makes it possible to share the conditions for the delivery of the content by sharing expected telemetry data values for the links established between the various nodes concerned and the user terminal depending on the transmission capacities of these links and the service required by the user of the user terminal. The shared register also enables the delivery of the content to be validated, or acknowledged, by consensus, which can then trigger the execution of transactions for the benefit of the various nodes depending on compliance with previously negotiated telemetry data values. This allows the various participants involved in the delivery of the content to check, at any time, the authenticity and integrity of the actions carried out as part of the delivery of the content and, consequently, to ensure that the delivery has taken place in compliance with the conditions established between the user terminal and the various nodes capable of delivering the requested content.

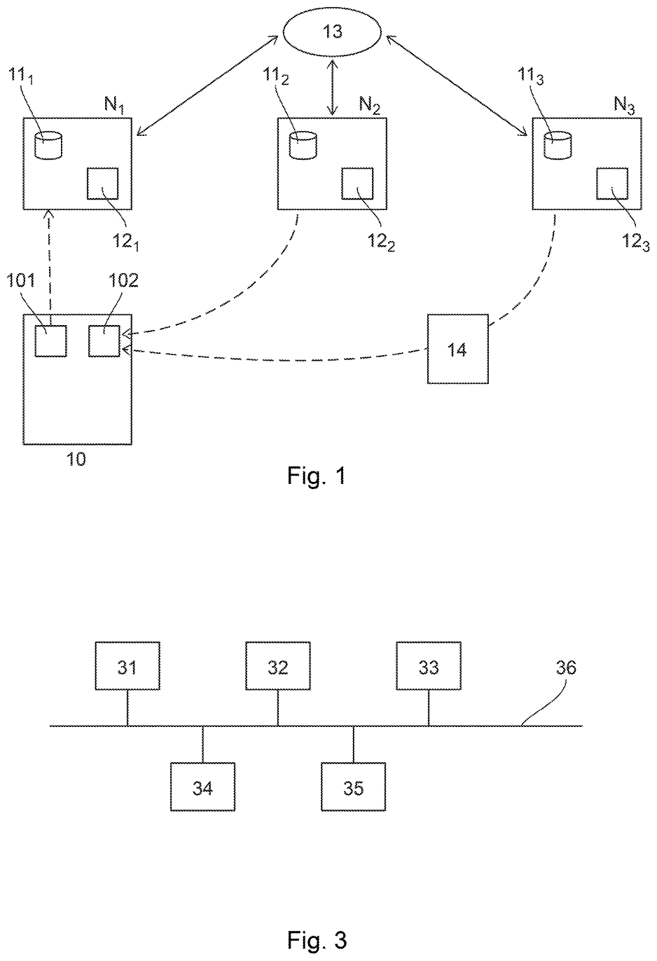

In relation to FIG. 1, a diagram of a system in which the present development may be implemented is now presented.

Such a system comprises a user terminal 10, such as a smartphone, a connected television set, a personal computer, a set-top-box, etc. Such a user terminal 10 comprises, among others, in the example considered here, a first communication interface 101 of the wired type or short-distance radio type such as Wi-Fi or Bluetooth, and at least one second communication interface 102 of the radio type compliant with the 4^{th} (4G) or 5^{th} generation (5G) of radio communication standards.

The system also comprises a plurality of nodes N₁-N₃. The described system can, of course, comprise more than three nodes. In any case, the system comprises at least two nodes in order to be able to propose a shared delivery of an item of content.

The first node N₁, referred to as the initiator node, belongs to a first content delivery network (not shown in the figures). Such an initiator node N₁ offers to deliver a given item of content. The initiator node N₁ comprises, among others, a cache server 11₁ storing at least one portion of the given content and a register 12₁, referred to as the initiator register.

The second node N₂, referred to as the follower node, can belong to the first content delivery network or to a second content delivery network (not shown in the figures). Such a follower node N₂ can also deliver a portion of the content offered for delivery by the initiator node N₁. The follower node N₂ comprises, among others, a cache server 11₂ storing at least one portion of the given content and a register 12₂, referred to as the follower register. The portion of the content delivered by the follower node N₂ can be the same as that delivered by the initiator node N₁, or a different portion.

The third node N₃, also referred to as the follower node, can belong to the first content delivery network, to the second content delivery network or to a third content delivery network (not shown in the figures). Just like the follower node N₂, the follower node N₃ can also deliver a portion of the content offered for delivery by the initiator node N₁. The follower node N₃ comprises, among others, a cache server 11₃ storing at least one portion of the given content and a register 12₃, referred to as the follower register. The portion of the content delivered by the follower node N₃ can be the same as that delivered by the initiator node N₁ and/or the follower node N₂, or a different portion.

The follower nodes N₂, N₃ can participate in the delivery of the content either by actually delivering one or more portions of the content, or by measuring telemetry data values relating to the delivery of the content or by participating in the validation of the delivery on the basis of measured telemetry data values relating to the delivery of the content.

The initiator register 11₁ and the two follower registers 11₂ and 11₃ constitute a shared register specific to the content offered for delivery by the initiator node N₁.

In a first particular implementation of the development, shown in FIG. 1, there are as many shared registers as there is content to be delivered. This provides a fine compartmentalisation of information, making it easier for each of the managers of the delivery networks concerned to manage the delivery of content.

In a second particular implementation, not shown in the figures, the system comprises, embedded in a network device of one of the content delivery networks, a synchronisation module 13 allowing the various registers 11₁, 11₂ and 11₃ to communicate with each other (and to synchronise) in order to implement the development. Such a module 13 can be a software module, a hardware module or a combination of both.

Regardless of the implementation chosen, the system can also comprise an interconnection module 14. Such an interconnection module 14 can be a module of type UPF (User Plane Function) between a mobile infrastructure of a 5G network and the data network or DSLAM (Digital Subscriber Line Access Multiplexer). Other types of interconnection modules 14 can, of course, be considered.

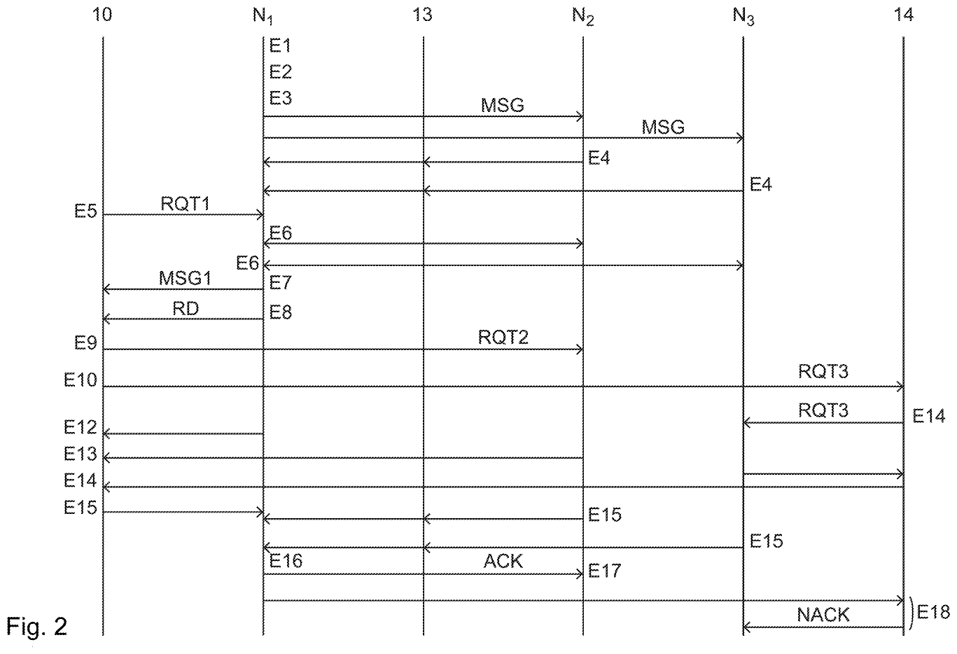

FIG. 2 shows a diagram of the various steps of the method for checking the delivery of an item of content covered by the development.

An initiator node N₁ storing an item of content Cont1 in a cache server 11₁ creates, in a step E1, a local register 12₁ dedicated to the delivery of the content Cont1. Such a local registry 12₁ is, for example, a single-file database such as an “SQLite” database, known per se. The local registry 12₁ comprises technical data relating to the delivery of the content Cont1 as defined in the RFC (Request For Comment) 8008 and 8006 documents published by the IETF (Internet Engineering Task Force). The local register 12₁ is also designed to store telemetry data values relating to the delivery of the content Cont1 and, in the embodiment described here, data relating to rewards associated with compliance with the telemetry values relating to the delivery of the content.

In a step E2, the initiator node N₁ initiates the creation of a shared register SR relating to the content Cont1 with at least one follower node N₂, N₃.

In a first embodiment, in a step E3, the initiator node N₁ broadcasts a message MSG indicating its ability to deliver the content Cont1 in a shared manner. The message MSG comprises a URL pointing to the local register 12₁ of the initiator node N₁, as well as shared delivery conditions such as a minimum bit rate, or a quality level, for example HD or 4K, of the portion of content to be delivered, a delivery period, etc.

The local register 12₁ of the initiator node N₁ comprises a “yaml” (Yet Another Markup Language) file specifying how the various local registers 12₂, 12₃ will interconnect when implementing the present solution.

An example of the content of such a “yaml” file is as follows:

```
apiVersion: apps/vx
kind: DeploymentEsclave
metadata:
  name: NameDeployment
  labels:
    app: LabelDeployment
spec:
  replicas: NombreDeReplicat
  selector:
    matchLabels:
      app: LabelDeployment
  template:
    metadata:
      labels:
        app: LabelDeployment
    spec:
      esclave: IDESCLAVE/IPESCLAVE
      containers:
        - name: NOMAPPLICATION
        image: NONCONTENEUR
        ports:
          - containerPort: port
        resources:
          limits:
            RESSOURCELIMITE
          requests:
            RESSOURCEDEMANDE
```

The local register 12₁ of the initiator node N₁ also comprises several files constituting sections of the shared delivery proposal initiated by the initiator node N₁ in which all the data required to deliver the content is listed.

For example, the local register 12₁ comprises, among others:
a section defining parameters for interconnecting the various local registers 121, 122, 123, such as identifiers of the interfaces to be used; the content of this section is defined in the RFC 7336, RFC 6707 and RFC 7337 documents published by the IETF (Internet Engineering Task Force);
a section about starting the interconnection once it has been set up;
a manifest section (.mdp) defining the various portions constituting the content Cont1;
a “CDNI Logging interface” section comprising the expected telemetry data values, such a section is defined in the RFC 7937 document published by the IETF.

These files can be in JavaScript Object Notation (JSON) format.

In a particular embodiment, all these files can be grouped into a compressed file such as a .zip file.

In a step E4, the follower nodes N₂, N₃ capable of participating in the delivery of the content Cont1 in compliance with the delivery conditions specified in the message MSG establish a connection with the initiator node N₁ via a synchronisation module 13. This connection established via the synchronisation module 13 enables the local registers 12₂, 12₃ created respectively by the follower nodes N₂, N₃ to be updated in response to the message MSG. The follower nodes N₂, N₃ transmit via this connection telemetry data values they are able to guarantee.

In order to secure the exchanges between the various local registers 12₁, 12₂, 12₃, the follower nodes N₂, N₃ can transmit an ACME (Certificates in Automated Certificate Management Environment) STAR (Support for Short-Term, Automatically-Renewed) temporary certificate whose principles are described in the RFC 8739 document published by the IETF or even an Oauth token. These elements enable the initiator node N₁ to manage the exchanges within the shared register SR.

In a second embodiment, the Kubernetes technology is used to synchronise the local registers 12₁, 12₂ and 12₃ with each other.

Typically, a Kubernetes node cluster comprises a first node referred to as the management node, or “Kubernetes master”, that corresponds here to the initiator node N₁, and N compute nodes, or “Kubernetes nodes”, that correspond here to the follower nodes N₂, N₃. Although they are part of the same Kubernetes node cluster, these nodes can belong to different content delivery networks.

In this second embodiment, the initiator node N₁ comprises, like any Kubernetes node, a controller, an API (Application Programming Interface) module and an ETCD database, corresponding to the local register 12₁, that consists of a dynamic configuration register for the follower nodes N₂, N₃.

The follower nodes N₂, N₃ also comprise an ETCD database, corresponding respectively to the local registers 12₂, 12₃.

With a view to reducing costs and improving the flexibility of network infrastructures, cloud computing architectures are most often multi-site architectures in which the nodes constituting node clusters can be non-co-located. For example, the initiator node N₁ and the follower node N₂ of a node cluster are located at a site A, while the follower node N₃ is located at a remote site B.

In such a case, it is necessary to synchronise the operating states of the various tasks performed by the nodes of the same node cluster to ensure that the required service, in this case the shared delivery of the content Cont1, is provided.

Thus, the local register 12₁ of the initiator node N₁ transmits a message requesting the creation of a local register 12₂, 12₃ dedicated to the content Cont1 to be delivered to the follower nodes N₂, N₃. Such a message is relayed by the synchronisation module 13. Once the local registers 12₂, 12₃ have been created, the initiator node N₁ transmits a configuration file to the follower nodes N₂, N₃. Once their local registers 12₂, 12₃ have validated and applied (stored) the configuration, the follower nodes N₂, N₃ inform the initiator node N₁ by transmitting a confirmation that the configuration has been taken into account.

Such a configuration file comprises several sections of the shared delivery proposal initiated by the initiator node N₁ in which all the data required to deliver the content is listed.

For example, the configuration file comprises among others:
a section defining parameters for interconnecting the various local registers 121, 122, 123, such as identifiers of the interfaces to be used; the content of this section is defined in the RFC 7336, RFC 6707, and RFC 7337 documents published by the IETF;
a section about starting the interconnection once it has been set up;
a manifest section (.mdp) defining the various portions constituting the content Cont1;
a “CDNI Logging interface” section comprising the expected telemetry data values, such a section is defined in the RFC 7937 document published by the IETF.

These files can be in JavaScript Object Notation (JSON) format.

Regardless of the embodiment chosen, the synchronisation of the local registers 12₁, 12₂, 12₃ embedded in each of the nodes N₁, N₂ and N₃ operates by means of a consensus algorithm, called RAFT.

The initiator node N₁ being at the origin of the creation of the shared register SR, it is designated as the master of the shared register SR without going through the traditional master election phase as is the case in a conventional mode of operation of the RAFT algorithm. Eliminating this election phase reduces the time needed to start up the shared register SR.

Once the shared register for the delivery of the content Cont1 has been created, the initiator node advertises its ability to deliver the content Cont1.

Thus, in step E5, the user terminal 10 sends a request RQT1 for the delivery of the content Cont1 to the initiator node N₁. The user terminal 10 has obtained an address such as a URL (Uniform Resource Locator) associated with the requested content, for example via a search engine, or via a video-on-demand application, etc.

Prior to transmitting the content Cont1 to the user terminal 10, the initiator node N₁ implements a step E6 of negotiating the transmission conditions of the content Cont1 with the follower nodes N₂, N₃, in particular depending on the location of the user terminal 10, for example by specifying whether the latter is located indoors or outdoors, as this has an impact on the quality of the transmission.

During this negotiation step, transmission conditions embodied in values of one or more item of telemetry data associated with a transaction, such as a payment or the performance of a service, are transmitted by the initiator node N₁ to the follower nodes N₂, N₃.

Telemetry data belong to a group comprising among others:
a transit period between the initiator node N₁, the follower nodes N₂, N₃ and the user terminal 10 for a data packet constituting the content Cont1,
an identifier of at least one interconnection module 14 routing at least one data packet constituting the content Cont1 between the initiator node N₁, the follower nodes N₂, N₃ and the user terminal 10, the identifier advantageously being able to comprise the identifier of an operator managing the interconnection module,
a transit time of a data packet constituting the content Cont1 through an interconnection module 14, corresponding to the moment when the interconnection module 14 receives, processes or transmits the data packet,
a time for a data packet constituting the content Cont1 to travel through the interconnection module 14,
a time for a data packet constituting the content to be processed by the interconnection module 14,
a quality of service, representative of the prioritisation of the data packet constituting the content Cont1, this quality of service can be, for example, represented by a qualitative indication of the packet processing when it is routed to the user terminal 10,
the reception without loss or retransmission of a group of data packets constituting the content Cont1,
a combination of the above-mentioned individual items of telemetry data of the group.

Naturally, other telemetry data can be used within the context of the present development. Thus, another item of telemetry data relates to a parameter representative of a quality of experience (also called QoE) of the user of the user equipment 10.

In a particular embodiment, the user terminal 10 proposes telemetry data values to the initiator node N₁ in the request RQT1. The telemetry data values proposed by the user terminal 10 are taken into account by the initiator node N₁ during the negotiation step E6.

Thus, the initiator node N₁ and the follower nodes N₂, N₃ select the offer that suits them, that is they select one or more transmission conditions that correspond to the situation of the user terminal 10, for example the location indoors or outdoors of the user terminal 10, the nature of the connection of the user terminal 10 to a communications network, i.e. wired or wireless, Wi-Fi, Bluetooth, etc., and its budget. Such transmission conditions are embodied in values of one or more items of telemetry data described above and associated with a transaction.

During this step E6, the local register 12₁ of the initiator node N₁ transmits to the local registers 12₂, 12₃ of the follower nodes N₂, N₃, a set of telemetry data values obtained from telemetry data values provided by the user terminal 10, telemetry data values provided by the initiator node N₁ as well as the telemetry data values provided by the follower nodes N₂, N₃ during step E4.

Thus, the user terminal 10 provides data relating to its connectivity or to a required quality of service. The nodes N₁, N₂ and N₃, for their part, determine in relation to their capacities whether they can satisfy the request of the user terminal 10. As an example, the user terminal 10 can impose a distribution of the content delivery between two links of different types: 30% of the content is delivered via a Wi-Fi connection and 70% of the content is delivered via a 5G connection.

The telemetry values provided can also comprise constraints on capacities, volumes, encodings, etc. To this end, the user terminal 10 can require 5 Mb to be delivered at 30% of the volume via a 5G connection and 70% of the volume via a Wi-Fi connection. The node N₁ translates these constraints into a distribution to the other two nodes, N₂ and N₃, depending on their respective capacities.

This set of telemetry data values is then subject to a validation by consensus. If the set of telemetry data values is accepted, then the delivery is made. If the set of telemetry data values is not accepted, in a first case the content is not delivered and the user terminal 10 turns to a node other than N₁ that can deliver the content. In a second case, the user terminal 10 can negotiate new telemetry data values with different constraints.

To validate the set of telemetry data values by consensus, each local register 12₂, 12₃ of a follower node N₂, N₃ transmits a validation item of information to the local register 12₁ of the initiator node N₁. If the follower node N₂, N₃ is able to deliver a portion of the content Cont1 in compliance with the set of telemetry data values proposed by the initiator node N₁, the item of validation information is an acknowledgement, if the follower node N₂, N₃ is not able to deliver a portion of the content Cont1 in compliance with the proposed set of telemetry data values, then the item of validation information is a rejection.

The validation information can be weighted, by means of a weighting coefficient, depending on the identity and function of the node issuing it. As a non-restrictive example, a follower node N₂ serving as an origin for the content Cont1 can have a weighting coefficient equal to two for validating data relating to a quality of experience or QoE, or even three if its function is to insert advertising content into a data stream. In another example, a node serving only as a relay can have a weighting coefficient equal to ½.

If the majority, weighted if applicable, of the follower nodes N₂, N₃ acknowledge the set of telemetry data values proposed by the initiator node N₁, then the local register 12₁ of the initiator node N₁ validates the set of telemetry data values and triggers the delivery of the content in compliance with the validated set of telemetry data values. These validated telemetry data values are then referred to as expected telemetry data values because they must be complied with for a transaction to be triggered.

In a first case, when the weighted majority of the follower nodes N₂, N₃ do not acknowledge the set of telemetry data values proposed by the initiator node N₁, then the local register 12₁ of the initiator node N₁ validates the rejection of the proposed set of telemetry data values and, depending on the specified operating mode, rejects the delivery of the content or triggers a new negotiation of the telemetry data values to be applied to this delivery.

In a second case, if the majority, weighted if applicable, of the follower nodes N₂, N₃ do not acknowledge the set of telemetry data values proposed by the initiator node N₁, then the local register 12₁ of the initiator node N₁ validate this fact, and the initiator node N₁ delivers the content in compliance with the validated set of telemetry data only with the nodes that have acknowledged the validated set of telemetry data.

In all cases, the local register 12₁ of the initiator node₁ informs each local register 12₂, 12₃ of the follower nodes N₂, N₃ of the acknowledgement status of the set of telemetry data values and of the identity of the nodes participating in the delivery of the content when it is implemented.

When it is noted that the delivery of the content is implemented, the initiator node N₁ transmits, in a step E7, a message MGS1 to the user terminal 10 identifying the set of telemetry data values validated during the negotiation step E6 (set of expected data values in the sense of the development).

In a particular implementation of the method covered by the development, the step E6 can be implemented prior to step E5.

In response to the request RQT1 for the delivery of the content Cont1, the initiator node N₁ sends one or more “redirect” messages RD to the user terminal 10 in a step E8.

Each message RD comprises a URL pointing to a follower node N₂, N₃ able to deliver one or more portions of the requested content Cont1. The message RD can also comprise, associated with each identified portion of the content Cont1, the corresponding expected telemetry data values.

In a step E9, the user terminal 10 sends a request RQT2 for the delivery a first portion of the content Cont1 to the follower node N₂. Such a delivery request RQT2 comprises an identifier of the portion of the content Cont1 requested to the follower node N₂ and possibly the corresponding expected telemetry data values.

In a step E10, the user terminal 10 sends a request RQT3 for the delivery of a second portion of the content Cont1 intended for the follower node N₃, this second portion can be identical to the first portion requested to the node N₂ or different. Such a delivery request RQT3 comprises an identifier of the portion of the content Cont1 requested to the follower node N₃ and possibly the corresponding expected telemetry data values. The delivery request RQT3 is received by the interconnection module 14, that transmits it in a step E11 to the follower node N₃.

It should be noted that steps E9 and E10 can be implemented successively or in parallel.

Upon receipt of the delivery requests RQT2, RQT3, each node concerned prepares the portion of the content to be delivered. In the embodiment described here, this preparation consists, among others, in inserting the validated telemetry data into the data stream carrying the data relating to the content to be delivered.

Thus, in a first implementation, each node N₁, N₂, N₃ delivering a portion of the content generates at least one data stream comprising data packets constituting the content Cont1, data packets carrying data for implementing a transaction relating to the transmission of a portion of the content Cont1 and data packets carrying a value of one or more expected items of telemetry data intended to be used to verify that the delivery acknowledgement conditions are met. The data packets carrying a value of one or more expected items of telemetry data are inserted on the fly into the data streams generated in this way.

In a second implementation, each node N₁, N₂, N₃ delivering a portion of the content generates a first data stream comprising the data packets constituting the content Cont1, a second data stream comprising the data carrying a value of one or more expected items of telemetry data, and optionally, a third data stream comprising the data for implementing a transaction relating to the transmission of the content Cont1. These three data streams are then multiplexed with a view to be transmitted to the user terminal 10. According to an example, each of these three data streams can take the form of a “stream” compliant with the QUIC (Quick UDP Internet Connections) protocol, currently being standardised by the IETF (Internet Engineering Task Force), the three streams then being multiplexed.

In a third implementation, each node N₁, N₂, N₃ delivering a portion of the content generates a first data stream comprising the data packets constituting the content Cont1 and a second signalling data stream in which is carried the data carrying a value of one or more expected items of telemetry data, and optionally, data comprising the data for implementing a transaction relating to the transmission of the content Cont1. According to one example, such data packets constituting the signalling data stream are, for example, TLS ClientHello and ServerHello data packets defined in the QUIC protocol.

In a fourth implementation, each node N₁, N₂, N₃ delivering a portion of the content generates a data stream comprising groups of pictures (GoP) constituting the compressed content Cont1 and a second signalling data stream in which are carried the data packets carrying a value of one or more expected items of telemetry data measuring the correct receipt of the first picture of the group of pictures, and optionally, data packets comprising the data for implementing a transaction relating to the transmission of the content Cont1. Such data packets constituting the signalling data stream are, for example, TLS ClientHello and ServerHello data packets defined as CHO and SHO in the QUIC protocol. In this fourth implementation, the delivery is only acknowledged when a group of packets constituting the first picture of the group of pictures is received by the user terminal without loss or retransmission.

In steps E12 to E14, according to one of the implementations described above, the user terminal 10 receives the requested portions of the content Cont1 from the initiator node N₁, the follower node N₂ and the follower node N₃ respectively. In the embodiment described, the portion of the content Cont1 delivered by the node N₃ is relayed by the interconnection module 14.

In a step E15, actual telemetry data values relating to the delivery of the different portions of the content Cont1 are written to the initiator register 12₁. These actual telemetry data values can be provided by the user terminal 10, by the nodes N₁, N₂, N₃ delivering the content, by other nodes involved in the delivery of the content whose only function is to measure the telemetry data values, by the interconnection module 14, etc. These actual telemetry data values written to the initiator register 12₁ are accompanied by information for verifying their integrity. Such information for verifying their integrity is, for example, an identifier of the node that provided these actual telemetry data values, a hash of the actual telemetry data values possibly completed by an identifier of the node that provided these actual telemetry data values, a function of the node that provided these actual telemetry data values, etc.

In a particular implementation of the present solution, this information for verifying the integrity of the actual telemetry data values can influence the value of the weighting coefficient associated with a given node. Thus, a node whose integrity cannot be questioned, such as the initiator node N₁, can be associated with a high weighting coefficient.

In a step E16, the local register 12₁ of the initiator node N₁ verifies the compliance of the actual content transmission conditions with the expected content transmission conditions negotiated during step E6, by comparing the actual telemetry data with the expected telemetry data.

Thus, in a first embodiment, when one of the items of telemetry data used is a transit period of a data packet constituting the content, the local register 12₁ of the initiator node N₁ determines a shifting period representative of a difference between an actual transit period of the data packet in question and an expected transit period negotiated during step E6.

When the local register 12₁ of the initiator node N₁ determines that the value of the shifting period is below a threshold negotiated, for example, also during step E6, the actual transit period and the expected transit period match. The actual transmission conditions are then considered to comply with the expected transmission conditions.

In a second embodiment, when one of the items of telemetry data is a transmission time of the data packet of the content, the local register 12₁ of the initiator node N₁ measures a difference between an actual transit time of a data packet constituting the content through the interconnection module 14 and an expected transit time of a data packet constituting the content through the interconnection module 14. If the difference determined in this way is below a threshold negotiated, for example, during step E6, the actual transit time and the expected transit time match. The actual transmission conditions are then considered to comply with the expected transmission conditions.

In a third embodiment, when one of the items of telemetry data is an identifier of at least one interconnection module 14 through which a data packet constituting the content must transit during its transmission to the user terminal 10, the local register 12₁ of the initiator node N₁ checks the presence of data packets introduced into the content by the interconnection module 14 and comprising an identifier of the interconnection module 14. If such an identifier of the interconnection module 14 is present, then the actual transmission conditions are considered to comply with the expected transmission conditions.

The interconnection module 14 can also insert time information such as, for example, arrival times, crossing periods, processing times of a previous sequence of data packets, etc., into the data packets they introduce into the content in order to enable the local register 12₁ of the initiator node N₁ to check compliance with other transmission conditions.

In a fourth example, when one of the items of telemetry data is the cryptographic key created by the content delivery application from the expected telemetry data values validated during the negotiation step E6, the local register 12₁ of the initiator node N₁ determines an “actual” cryptographic key from the actual telemetry data. If the “actual” cryptographic key obtained in this way matches the cryptographic key created by the content delivery application, then the actual transmission conditions are considered to comply with the expected transmission conditions.

The four embodiments described above can be implemented together.

At the same time, in the embodiment described here, the local register 12₁ of the initiator node N₁ transmits to the local registers 12₂, 12₃ of the follower nodes N₂, N₃ the actual telemetry data values collected during step E15, triggering the validation by consensus process for this data.

Each local register 12₂, 12₃ of a follower node N₂, N₃ then performs its own verification of the actual telemetry data values collected by comparing the actual telemetry data values available to it with the expected telemetry data values, and transmits an item of validation information to the local register 12₁ of the initiator node N₁. If the follower node N₂, N₃ also considers that the actual telemetry data values match the expected telemetry data values, it validates this information and issues an acknowledgement. If the follower node N₂, N₃ considers that the actual telemetry data values do not match the expected telemetry data values, it invalidates this information and issues a rejection.

When the actual telemetry data values written to the initiator register 12₁ are accompanied by information for verifying their integrity, this integrity is also verified by each of the local registers 12₂, 12₃, before they are validated.

If when the follower node N₂, N₃ considers that the actual telemetry data values match the expected telemetry data values and that the information for verifying their integrity is also valid, it issues an acknowledgement.

If the follower node N₂, N₃ considers that at least one of the items of information for verifying the integrity of the actual telemetry data values is not valid because it corresponds, for example, to a non-referenced node, then the local register 12₂, 12₃ of a follower node N₂,N₃ invalidates this information and issues a rejection. Indeed, only one invalid item of information for verifying the integrity of the actual telemetry data values compromises the integrity of all the data stored in the shared register. It should be noted that in the embodiment described here, the node N₁ transmits to the other nodes N₂, N₃ the actual telemetry data values collected during step E15. As a variant, the node N₁ can transmit to the other nodes N₂, N₃ the result of its comparisons between the actual telemetry data values collected during step E15 and the expected telemetry data values, and optionally information for verifying the integrity of these comparison results. In this case, the follower nodes N₂, N₃ compare their own comparison results and transmit an acknowledgement to the node N₁ if they obtain the same results as the node N₁, or a rejection otherwise. If they have information for verifying the integrity of the comparison results received from the node N₁, they perform this verification.

When the majority, possibly weighted, of the follower nodes N₂, N₃ do not acknowledge the actual set of telemetry data values, then the local register 12₁ of the initiator node N₁ validates the rejection of the content delivery.

If, despite everything, the content has actually been received by the user terminal 10, a transaction triggered may be the payment of a credit to compensate for the non-compliance with the delivery conditions, or the free delivery of another item of content.

If the content could not be delivered to the user terminal, the initiator node N₁ can trigger a new delivery based on the same expected telemetry values or on new expected telemetry values previously validated by consensus.

If the majority, possibly weighted, of the follower nodes N₂, N₃ acknowledge the actual telemetry data values, then the local register 12₁ of the initiator node N₁ acknowledges the delivery of the content.

The local register 12₁ of the initiator node N₁ then informs each local register 12₂, 12₃ of the follower nodes N₂, N₃ that the actual telemetry data values are validated, and that therefore the delivery of the content Cont1 is acknowledged.

The initiator node N₁ then triggers the transactions relating to the delivery of the content Cont1 in a step E16.

It should be noted that in case of failure of the initiator node N₁, or when the follower nodes N₂, N₃ consider that the initiator node N₁ is not performing its functions satisfactorily, the follower nodes N₂, N₃ can trigger the election of a new initiator node. Such a mechanism for electing a new initiator node is a classic mechanism of the RAFT algorithm.

In a step E17, the initiator node N₁ transmits an acknowledgement message ACK to the nodes N₂, N₃ and the interconnection module 14 indicating that the content Cont1 has been delivered in compliance with the expected telemetry values. This can take the form of a payment receipt confirming that the payment transaction has been completed, or a message indicating that the requested service has been provided and the corresponding transaction has been completed.

If the actual telemetry values are considered not to comply with the expected telemetry values, the initiator node N₁ sends, in a step E18, a failure message NACK to the node concerned, in this case N₃, indicating that although the content has been delivered to the user terminal 10, the delivery of its portion has not taken place in compliance with the expected telemetry values.

In this case, either the transaction is not triggered and the operator of the content delivery network CDN to which the node N₃ belongs receives no compensation for this delivery, or the operator of the content delivery network CDN still receives a compensation, but a lesser one. Such a lesser compensation can be a transaction corresponding to a payment that is lower than the maximum payment that can be received when all the telemetry data values are complied with.

The failure message NACK can also comprise an invitation to implement a new delivery of the portion of the content with new expected telemetry values.

When the content Cont1 is no longer available, the shared register SR is closed and archived. If there are still transactions to be triggered, the local register 12₁ of the initiator node N₁ processes them before closing the shared register SR.

FIG. 3 shows a node N₁, N₂, N₃ according to one embodiment: of the development. Such a node N₁, N₂, N₃ is able to implement the method for checking the delivery of an item of content according to FIG. 2.

A node N₁, N₂, N₃ can comprise at least one hardware processor 31, a storage unit 32, an input device 33, a display device 34, and at least one network interface 35 which are connected to each other via a bus 36. Naturally, the elements constituting the node N₁, N₂, N₃ can be connected by means of a connection other than a bus.

The processor 31 controls the operations of the node N₁, N₂, N₃. The storage unit 32 stores at least one program for implementing the method according to one embodiment of the development to be executed by the processor 31, and various data, such as parameters used for calculations performed by the processor 31, intermediate data for calculations performed by the processor 31, etc. The processor 31 may be formed by any known and appropriate hardware or software, or by a combination of hardware and software. For example, the processor 31 can be formed by a dedicated hardware such as a processing circuit, or by a programmable processing unit such as a Central Processing Unit which executes a program stored in a memory thereof.

The storage unit 32 may be formed by any appropriate means capable of storing the program or programs and data in a computer-readable manner. Examples of storage devices 32 include non-transitory computer-readable storage media such as semiconductor memory devices, and magnetic, optical or magneto-optical recording media loaded into a read/write device.

The input device 33 may be formed by a keyboard, a pointing device such as a mouse to be used by a user to enter commands. The display device 34 may also be formed by a display module, such as a GUI (Graphical User Interface).

The network interface 35 provides a connection between the node N₁, N₂, N₃, the interconnection module 14 or the synchronisation module 13.

1. A method of checking a delivery of an item of content to a user terminal made by a plurality of nodes belonging to at least one content delivery network, the nodes being able to deliver one or more portions of the content, the method being implemented by a first node, referred to as the initiator node, selected from the plurality of nodes and comprising:
calculating results of comparisons, for a plurality of portions of the content delivered, of values of at least one actual item of telemetry data with corresponding values of at least one expected item of telemetry data,
receiving at least one result of the same comparisons performed by at least one second node, referred to as the follower node, selected from the plurality of nodes, and
acknowledging the delivery of portions of the content when at least a majority of the comparison results obtained indicate compliance of the values of at least one actual item of telemetry data with the corresponding values of at least one expected item of telemetry data.

2. The method of checking a delivery of an item of content according to claim 1, wherein the comparison results are weighted to determine whether a majority of the comparison results obtained indicate the compliance.

3. The method of checking a delivery of an item of content according to claim 2, wherein a value of a weighting coefficient to be applied to the comparison results depends on at least one function implemented by nodes belonging to the plurality of nodes.

4. The method of checking a delivery of an item of content according to claim 1, wherein the comparison results and/or the at least one actual item of telemetry data are accompanied by at least one item of information for verifying their integrity.

5. The method of checking a delivery of an item of content according to claim 4, wherein, when the integrity of at least one of the comparison results and/or of one actual item of telemetry data is not verified, the delivery of portions of the content is not acknowledged.

6. The method of checking a delivery of an item of content according to claim 4, wherein an item of information for verifying the integrity of the comparison results and/or of the at least one actual item of telemetry data comprises a list comprising identifiers of nodes belonging to the plurality of nodes and/or comprises a hash of the data constituting at least comparison results and/or of the at least one actual item of telemetry data, and/or relates to at least one function implemented by nodes belonging to the plurality of nodes.

7. The method of checking a delivery of an item of content according to claim 1, comprising, prior to the delivery of portions of the content, creating a shared register intended to store data relating to the delivery of portions of the content and to validate telemetry data relating to the delivery of portions of the content.

8. The method of checking a delivery of an item of content according to claim 7, wherein creating the shared registry comprises:
broadcasting a message comprising an address of a local register of the initiator node relating to the delivery of the content, and
receiving a request to establish a connection between the local register of the initiator node and a local register of at least one follower node through which the data relating to the delivery of the content is exchanged.

9. The method of checking a delivery of an item of content according to claim 1, wherein acknowledging the delivery of portions of the content triggers a payment transaction.

10. The method of checking a delivery of an item of content according to claim 1, wherein an item of telemetry data belongs to a group comprising:
a transit period between the initiator node, the follower nodes and the user terminal of a data packet constituting the content,
an identifier of at least one interconnection module routing at least one data packet constituting the content between the initiator node, the follower nodes and the user terminal, the identifier can comprise the identifier of an operator managing the interconnection module,
a transit time of a data packet constituting the content through an interconnection module, corresponding to the time when the interconnection module receives, processes or transmits the data packet,
a time for a data packet constituting the content to travel through the interconnection module,
a time for of a data packet constituting the content to be processed by the interconnection module,
a quality of service, representative of the prioritisation of the data packet constituting the content, this quality of service can be represented by a qualitative indication of the packet processing when it is routed to the user terminal,
receiving without loss or retransmission a group of data packets constituting the content, and
a combination of the above-identified individual items of telemetry data of the group.

11. A node of a content delivery network, referred to as the initiator node, capable of checking a delivery of an item of content to a user terminal made by a plurality of other nodes, the nodes being able to deliver one or more portions of the content, the initiator node comprising means for:
comparing, for a plurality of portions of the content delivered, values of at least one actual item of telemetry data with corresponding values of at least one expected item of telemetry data,
receiving at least one result of the same comparisons performed by at least one second node, referred to as the follower node, selected from the plurality of nodes, and
acknowledging the delivery of portions of the content when at least a majority of the comparison results obtained indicate compliance of the values of at least one actual item of telemetry data item with the values of at least one expected item of telemetry data.

12. A processing circuit comprising a processor and a memory, the memory storing program code instructions of a computer program for implementing the method for checking a delivery of an item of content according to claim 1 when the computer program is executed by the processor.

13. A system comprising at least one user terminal and a plurality of nodes belonging to at least one content delivery network, the nodes being able to deliver one or more portions of an item of content to the user terminal, wherein the system having a first node referred to as the initiator node selected from the plurality of nodes comprises means for:
calculating results of comparisons, for a plurality of portions of the content delivered, of values of at least one actual item of telemetry data with corresponding values of at least one expected item of telemetry data,
receiving at least one result of the same comparisons performed by at least one second node, referred to as the follower node, selected from the plurality of nodes, and
acknowledging the delivery of the content when at least a majority of the comparison results obtained indicate compliance of the values of at least one actual item of telemetry data item with the corresponding values of at least one expected item of telemetry data.
